(19) United States
(12) Patent Application Publication
(10) Pub. No.: US 2008/0121111 A1
(43) Pub. Date: May 29, 2008

(54) Unit for Preparing at Least One Espresso Coffe Cup or Other Hot Beverage From a Prepackaged Single So-Called Coffee Pod

(75) Inventors: Arnaud Paget, Obernai (FR); Jean-Michel Bargot, Besancon (FR); Dominique Souin, Dorlisheim (FR)

Correspondence Address: DAVIS BUJOLD & Daniels, P.L.L.C., 112 PLEASANT STREET, CONCORD, NH, 03301, US

(73) Assignee: Reneka International, Rosheim (FR)

(21) Appl. No.: 11/632,509

(22) PCT Filed: Jul. 8, 2005
(86) PCT No.: PCT/FR05/01781

§ 371 Date: Jan. 7, 2008

(30) Foreign Application Priority Data
Jul. 16, 2004 (FR) 0407906

(51) Int. Cl. A47J 31/40

(52) U.S. Cl. 99/295

(57) ABSTRACT

The invention concerns a unit (1) for automatically preparing espresso coffee from prepackaged coffee pods containing one or two coffee pods and comprising a mechanism for individually detecting the presence of each pod in its location. It comprises a drawer (5) movable between a position for extracting, a position for loading and a position for discharging pods and an injection unit (6) closing the support of the preparation unit (1) in its front part above the drawer (5) in its extracting position and entirely mobile to be brought closer to the drawer through the cams (29) of the camshaft (7) driven by a single motor (8), being automatically returned away from the injection unit (6) through a return force. The invention is of interest to professional coffee machine manufacturers.

This is a national stage completion of PCT/FR2005/001781 filed Jul. 8, 2005 which claims priority from French Application Serial No. 0407906 filed Jul. 16, 2004.

### FIELD OF THE INVENTION

The present invention concerns an automatic unit for preparing at least one cup of espresso-type coffee with a professional coffee maker using at least one single prepackaged unit called a pod.

More generally, the present invention concerns a device for preparing a hot beverage using pressurized hot water and at least one pod containing the amount of product to be extracted by the amount of hot water used for one serving of beverage.

### BACKGROUND OF THE INVENTION

Usually such coffee machines utilize one or more preparation units, with the user attaching to each unit a detachable filter holder comprising a strainer previously filled with one serving of coffee. After the user has pressed the coffee selection keypad, an internal pump in the machine is set in motion and the water is subjected to pressure before passing through a flow meter that circulates the amount of water determined by the type of coffee selected towards a heating element. This measured amount of heated water reaches and then is discharged through a spray head, then passes through the coffee in the strainer inside the filter holder. The only remaining step is to collect the hot coffee flowing through the spout of the filter holder in a cup placed beneath it.

In general, commercial restaurant or bar machines comprise filter holders with two spouts so two cups can be filled simultaneously. The number of preparation units varies according to the size of the machine.

The traditional method for making espresso using these machines, before the advent of pods, consisted of using ground coffee packed into a filter holder using a flat device to tamp it down. However, this is a relatively long and messy, labor-intensive process.

For this reason, the use of a prepackaged pod of ground coffee for each cup has developed gradually and is now common. The method has proven to be more practical, faster, cleaner and more hygienic, in addition to offering precise and consistent control over the amount and grind of coffee and preserving the coffee aroma when the pods are packaged in individual hermetically sealed units. It also allows a great variety of coffees to be offered, such as mixtures or blends that do not require an establishment to stock a large number of packages of coffee corresponding to the selections offered. In any event, this problem existed previously with regular and decaffeinated coffee.

In this context, coffee roasters and manufacturers of coffee makers have developed a standard type serving containing seven grams of coffee and shaped like two saucers joined along their peripheral rims. These pods are designated by the name “ESE pods” (Easy Serving Espresso) and can be used in most single serving coffee machines, even if other coffee roasters have preferred to create their own pod format.

These units may be manually introduced directly into the machine and positioned in the place provided, which can be awkward when the location is difficult to access and/or even dangerous if the user must stick his hand into the machine, or they may be introduced through a slot. In the latter case they may be introduced vertically on a slide along which each unit moves to the place provided, or there may be a horizontal drawer with placements for the pods.

The use of such a drawer offers several advantages: in particular, it is extremely easy and quick to place the pods on it, with this procedure taking place outside the machine and posing no danger to the user's hands. For this reason, the invention concerns a preparation unit that uses this loading method.

Thus, several devices have been proposed for infusion beverage preparation machines to automatically manipulate and load prepackaged beverage pods using a drawer.

For example, Application No. WO 00/49926 in the name of SIMAC VETRELLA discloses an automatic loading and preparation device with a translationally movable drawer for one or more pods that are ejected in two stages just before the next serving is made.

Application No. EP 1050258 in the name of EUROMATIK describes an automatic loading and preparation device with a translationally movable drawer for a single pod that is ejected in two stages just before the serving cup is made.

Another solution is divulged in application WO No. 02/38016 in the name of SMILE COFFEE which describes an automatic loading and preparation device using several actuators, with a pivoting drawer used for a single pod.

Application No. EP 1153561 in the name of NESTLE describes an automatic loading and preparation device with a translationally movable drawer for a single non-ESE pod that is ejected just before the next serving is made.

Finally, Application No. EP 1219216 in the name of NESTLE describes an automatic loading and preparation device with a translationally movable drawer for two non-ESE type pods only that are ejected just before the next serving is made.

However, these automatic pod loading and coffee preparation devices do not allow two pods to be positioned and used simultaneously, and even in that case, it is still not possible to utilize one at a time to prepare a single cup of coffee. Moreover, none of the devices described above can detect whether or not a pod is present, meaning that when only one of the pod placement areas is in use, it is the user who must inform the machine. It would be much more advantageous if the automatic loading and preparation device could be supplied with two pods simultaneously and had an individual means of detecting the presence of each pod.

Furthermore, these devices do not always discharge the pod at the end of the cycle; the pod is often ejected just before the next cup of coffee is prepared. Thus, the moist pod remaining in position or on an intermediate support that is often inaccessible constitutes a significant disadvantage when the machine is stopped for long periods of time. It can deteriorate quickly and become infested with germs or mold proliferating in the receptacles and the circuit, which is detrimental to coffee quality and even dangerous to the health of the consumer. Therefore, it is important for the pod to be ejected automatically once used up and immediately after use.

Moreover, certain of these devices do not use ESE format pods, but pods of a specific format which are often more costly. Therefore it would be highly advantageous if the device could use ESE format pods, or even other types of prepackaged pods or all existing types.

Consequently, the object of the invention is to provide a complete unit for automatically preparing espresso-type coffee or other beverages from prepackaged pods that is equipped with a drawer for a beverage device accommodating at least one and at the most two pods, and comprising an individual means of detecting the presence of each pod in its placement. Advantageously this device would be capable of using numerous types of prepackaged pods, particularly ESE format pods, and these should be ejected automatically at the end of the cycle.

Preferably this device would be designed to be dependable and economical, simple and quick to use, and safe for both the user and the consumer.

### SUMMARY OF THE INVENTION

To resolve this technical problem, the unit for automatically supplying and preparing beverages from prepackaged pods according to the invention is composed of a fixed mechanical support designed to be mounted in a coffee or beverage preparation machine, especially for hot beverages. The machine comprising the additional elements necessary for the unit to operate, specifically, a pressurized heating unit, one or more hot water outlets, one or more steam outlets, and a control panel for controlling the unit.

The preparation unit of the invention comprises in the lower portion a drawer moving in horizontal translation which comprises a tilting receiving platform equipped with two strainers housed on a filter holder attached to its upper surface and which forms, along with its support, a hatch tilting on a horizontal axis located in the front portion of the receiving platform. It is kept closed with the help of a locking mechanism. This receiving platform communicates at the lower portion with several elements that conduct the prepared beverage downward into a suitable receptacle, for example, a mug or a cup.

In its upper portion the unit of the invention includes an injection block movable in vertical translation, comprising on its lower surface two spray heads movable in vertical translation like a piston within a protective sleeve and affixed tightly to the lower surface of the injection block. These spray heads are provided for connection to the hydraulic circuit of the machine.

The movable injection block is displaced in vertical translation by a single motor mechanism using a mechanical transmission to drive several movable elements of the unit, one of which is the injection block, using a cam shaft that always turns in the same direction for the entire cycle without the need for any course recovery system related to wear. Preferably this cam shaft also controls the opening of the system that locks the tilting receiving platform in order to automatically eject pods at the end of the cycle.

In addition, the movable injection block comprises an individual means for automatically detecting the presence of a pod in either or both strainers in the lower platform. This detection means consequently activates the hydraulic system in the machine for either or both individual pod positions.

Thus, the preparation unit according to the invention offers numerous advantages, among which are the following:

the drawer principle;

automatic ejection at the end of each coffee preparation cycle;

automatic and individual detection of the presence of each pod;

simultaneous but individual processing of two pods at once;

a single motor for the entire preparation cycle always turning in the same direction;

absence of any course recovery system associated with wear;

decompression of the chamber prior to the opening of the tilting receiving platform;

synchronized control of catches locking the tilting receiving platform;

the use of a force to remove used pods; and

automatic closing of the tilting receiving platform when the drawer opens.

### BRIEF DESCRIPTION OF THE DRAWINGS

Other characteristics and features of the invention will be apparent from reading the following detailed description, with reference to the attached drawings, in which:

FIG. 1 is an overhead perspective view of an entire conventional coffee machine equipped with two groups of automatic pod loading and preparation units according to the invention in the open position;

FIG. 2 is side view of the entire unit of the conventional coffee machine of FIG. 1 with a cup positioned in it and with the two units according to the invention in the extraction position;

FIG. 3 is a perspective view of an automatic pod loading and preparation unit according to the invention with the drawer in open position;

FIG. 4 is a perspective view of an automatic pod loading and preparation unit according to the invention with the drawer in closed position;

FIG. 5 is an exploded perspective view of an automatic pod loading and preparation unit according to the invention;

FIG. 6 is an overhead perspective view of the drawer of the automatic pod loading and preparation unit according to the invention with the tilting receiving platform in closed position;

FIG. 7 is a perspective view from below of the drawer of the automatic pod loading and preparation unit according to the invention with the tilting receiving platform in open position;

FIG. 8 is an exploded view of the drawer of the automatic pod loading and preparation unit according to the invention;

FIG. 9 is an overhead perspective of the tilting receiving platform on the drawer according to the invention;

FIG. 10 is a perspective from below of the tilting receiving platform on the drawer according to the invention;

FIG. 11 is an exploded perspective of the tilting receiving platform of the drawer according to the invention;

FIG. 12 is an overhead perspective of the entire injection block according to the invention;

FIG. 13 is a perspective from below of the entire injection block according to the invention;

FIG. 14 is an exploded view of the entire injection block according to the invention;

FIG. 15 is a simplified vertical transverse cross-sections of a unit according to the invention showing a first principal stage of one operating cycle.

FIG. 16 is a simplified vertical transverse cross-sections of a unit according to the invention showing a second principal stage of one operating cycle.

FIG. 17 is a simplified vertical transverse cross-sections of a unit according to the invention showing a third principal stages of one operating cycle.

FIG. 18 is a simplified vertical transverse cross-sections of a unit according to the invention showing a fourth principal stage of one operating cycle.

FIG. 19 is a simplified vertical transverse cross-sections of a unit according to the invention showing a fifth principal stage of one operating cycle.

FIG. 20 is a simplified vertical transverse cross-sections of a unit according to the invention showing a sixth principal stage of one operating cycle.

FIG. 21 is a simplified vertical transverse cross-sections of a unit according to the invention showing a seventh principal stage of one operating cycle.

FIG. 22 is a simplified vertical transverse cross-sections of a unit according to the invention showing an eighth principal stage of one operating cycle.

FIG. 23 is a simplified vertical transverse cross-sections of a unit according to the invention showing a ninth principal stage of one operating cycle.

FIG. 24 is a simplified vertical transverse cross-sections of a unit according to the invention showing a tenth principal stage of one operating cycle.

FIG. 25 is a simplified vertical transverse cross-sections of a unit according to the invention showing an eleventh principal stage of one operating cycle.

### DETAILED DESCRIPTION OF THE INVENTION

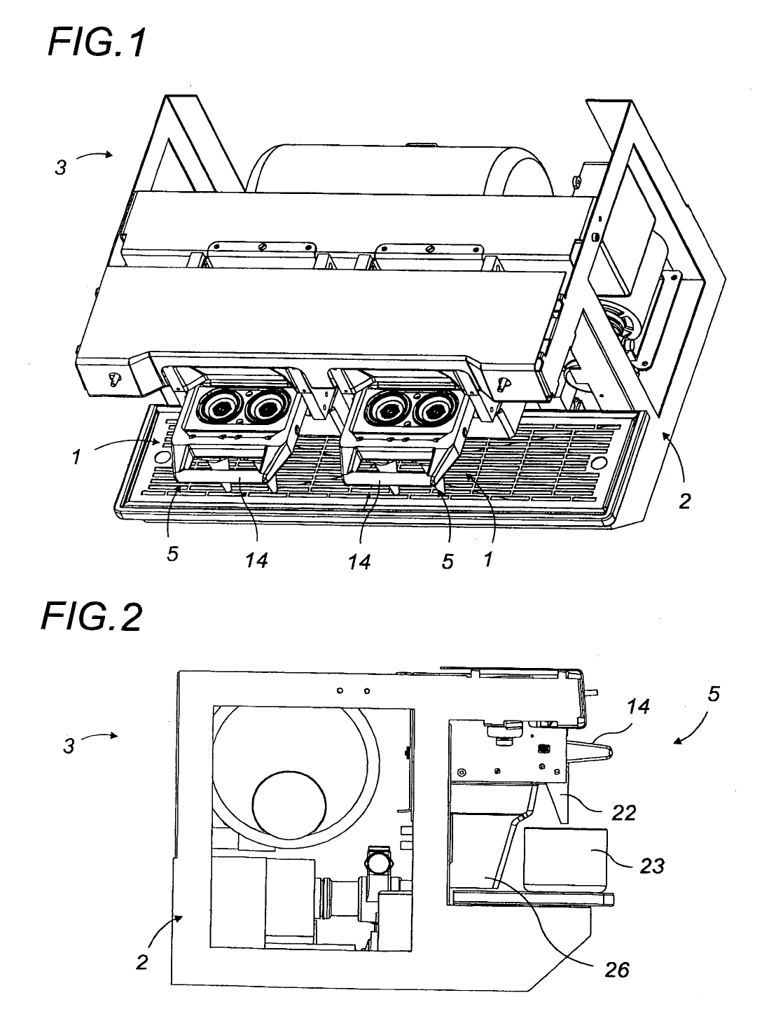

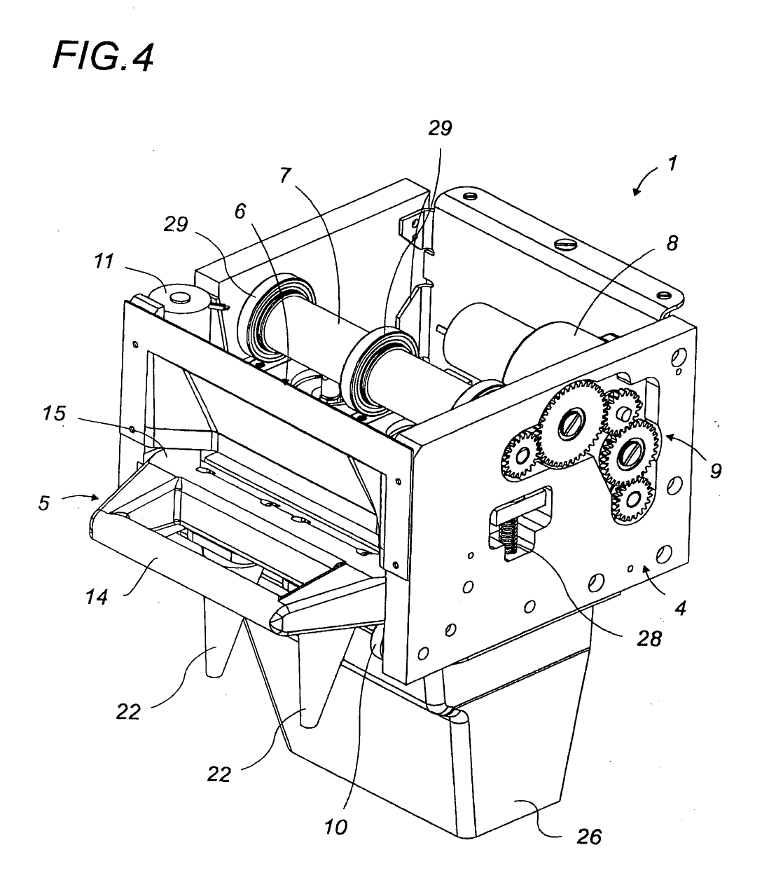

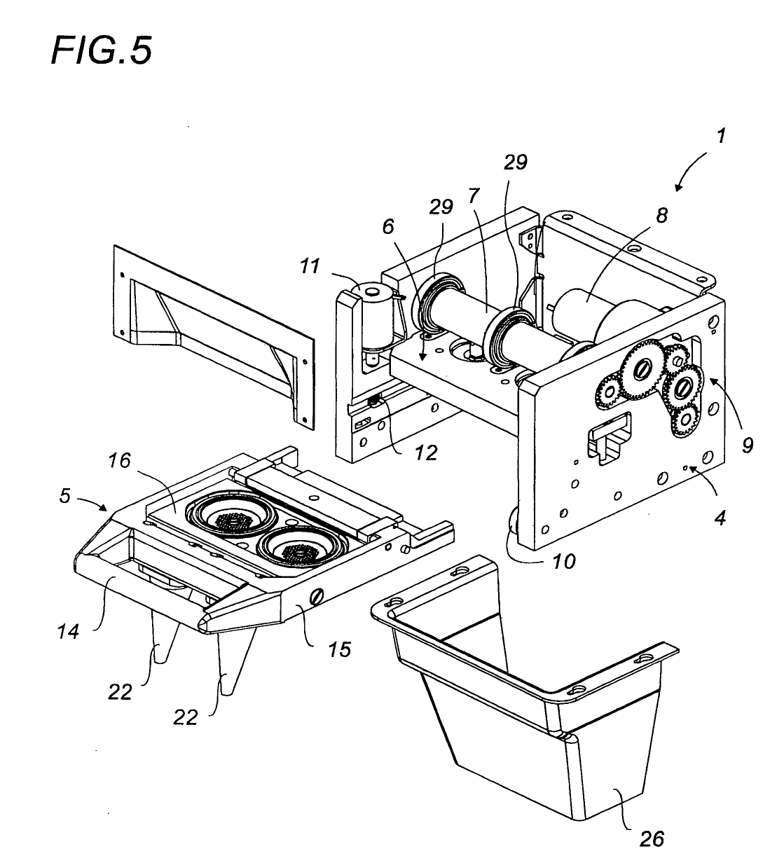

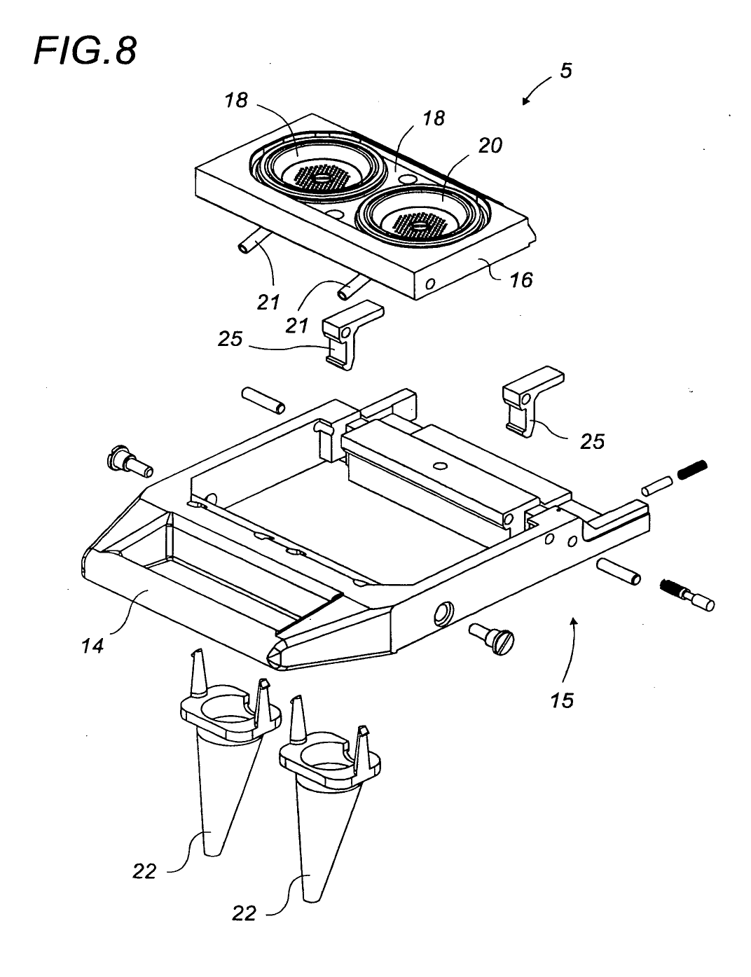

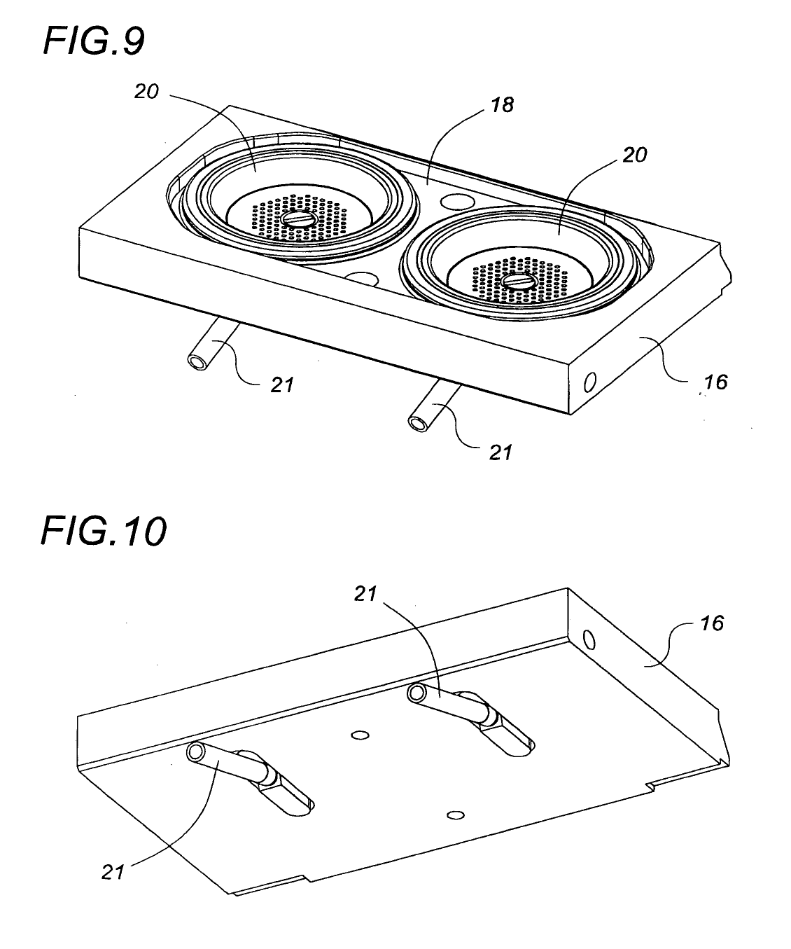

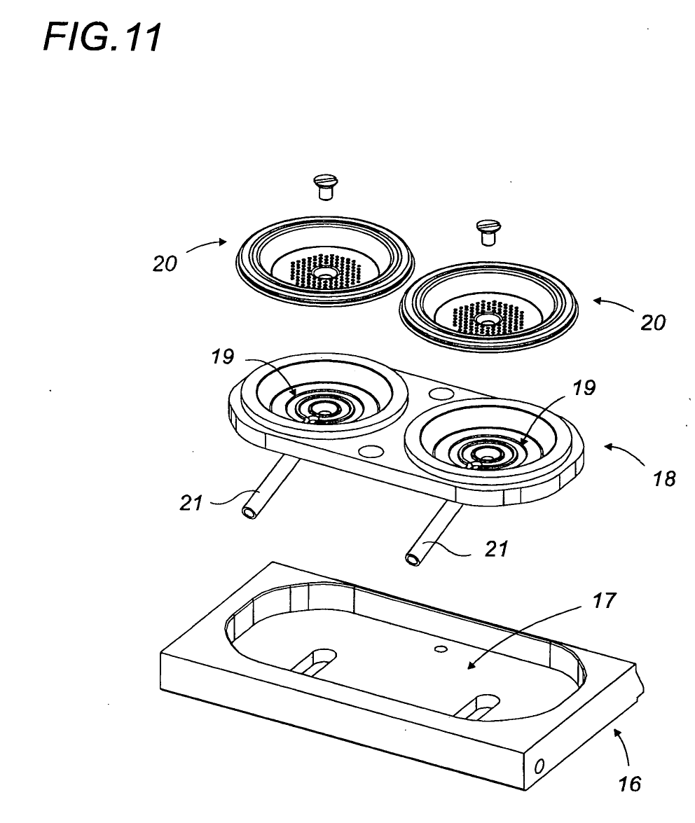

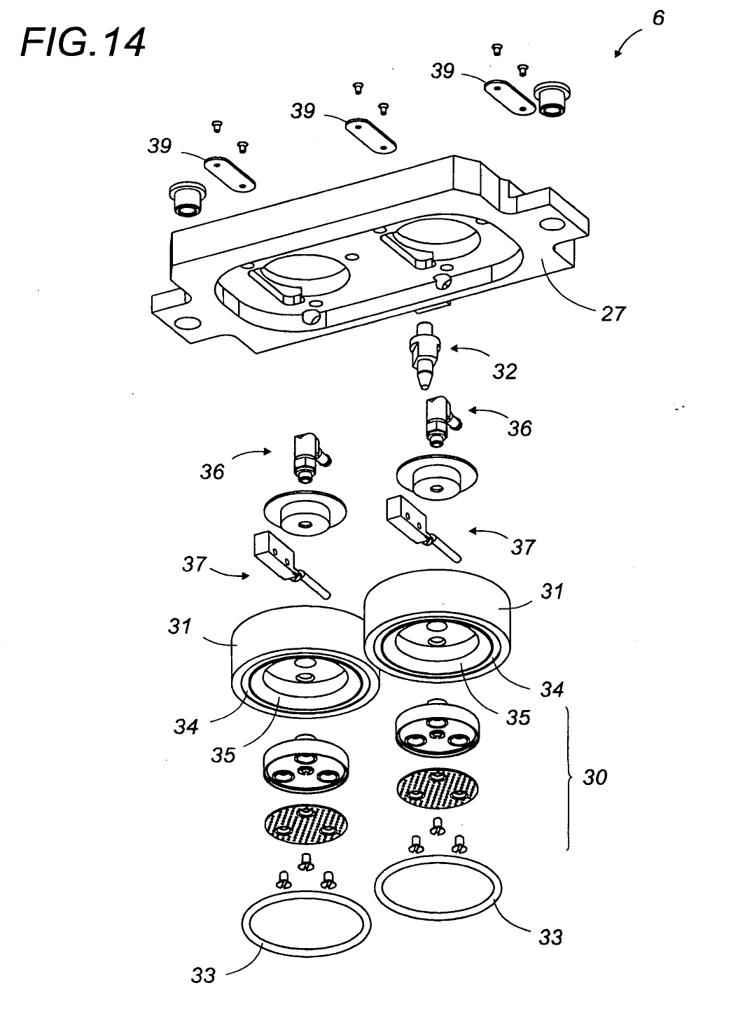

The coffee preparation unit according to the present invention will now be described in a detailed fashion with reference to FIGS. 1-25. Equivalent elements shown in different drawings will bear the same reference numerals.

The term coffee should hereafter be understood as denoting any beverage, particularly a hot beverage, made by hydraulic extraction of a product contained in a prepackaged pod, whether it is coffee, tea, or any other product or mixture of products for preparing a beverage. Similarly, the term coffee machine here means any automatic, semi-automatic, or public vending machine operated with coins or tokens for the preparation of beverages by extraction using a prepackaged pod.

The unit according to the invention for the preparation of espresso coffee from at least one pod, such as those shown in FIGS. 1 and 2), principally designed to be mounted on a professional coffee machine of the type that exists in bars, restaurants, communal gathering places, and other places where beverages are consumed. These machines supposedly prepare espresso in the best way possible because they utlilize optimal espresso coffee preparation conditions insofar as water temperature, pressure, quantity, and speed of execution are concerned.

These machines, with one or more preparation units, generally comprise a water inlet, a pressurized heating unit, a hydraulic system, one or more hot water outlets, and one or more steam outlets.

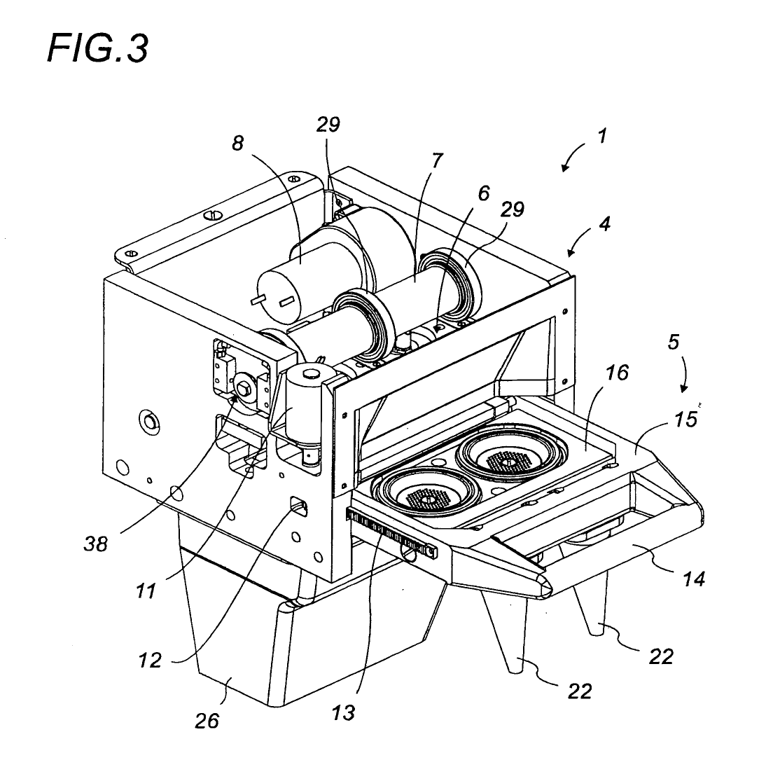

Unit 1 according to the invention, as shown in FIGS. 3-5, consists of a functional unit for mounting on the frame 2 of coffee machine 3. Each machine 3 can accommodate one, two, three, or even four or more units depending on its capacity.

The functional unit is a mechanical support 4 that contains all the components forming the functional unit of preparation unit 1 according to the invention.

It includes the following elements:

a drawer 5 movable between an extraction position, a loading position, and a position for the evacuation of one or more pods;

an injection block 6 closing support 4 in its upper front portion above drawer 5 in its extraction position, movable in its entirety toward and away from drawer 5;

a cam shaft 7 activating the injection block 6 to move towards the drawer 5, while its return movement away from the drawer 5 is effected automatically by a recall force;

a single drive motor 8 for the entire operating cycle and all the elements; and

a means 9 for transmitting movement from the output of the single motor to the elements it controls.

Now the various general elements outlined above will be set forth in detail.

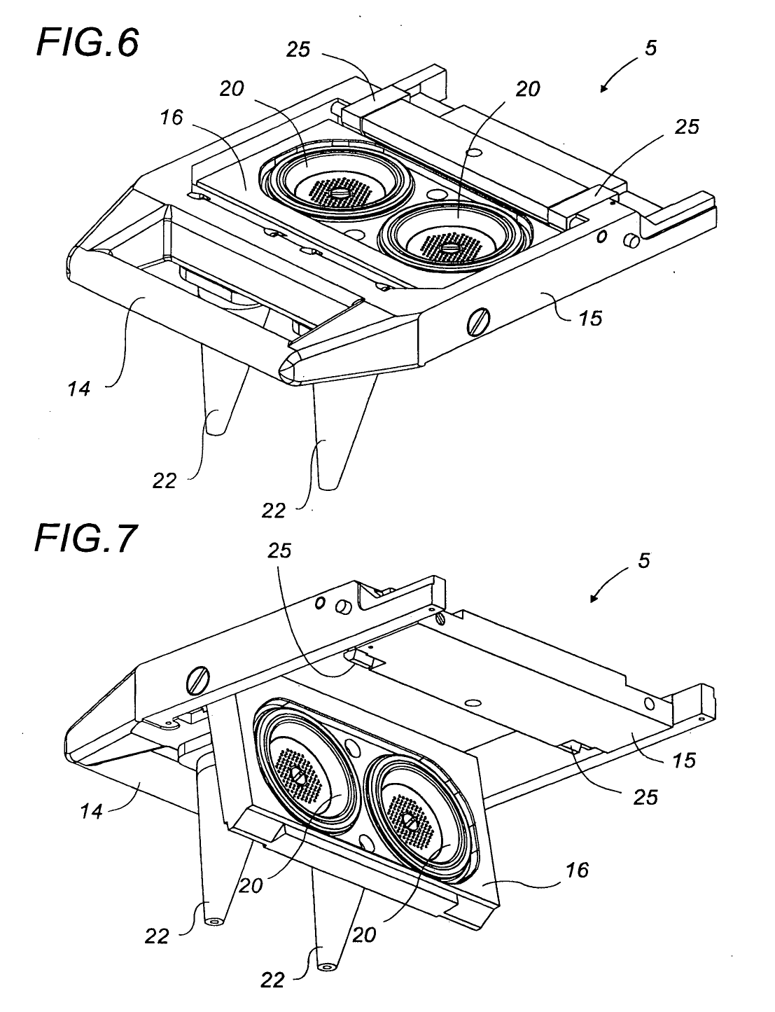

Movable drawer 5, shown in FIGS. 6-8, is a unit moving in horizontal translation, for example on rollers 10, between and extended position and a return position. It may optionally be equipped with a motorized activator using a separate auxiliary motorized device 11 and with a pinion mechanism 12 engaging a rack 13 attached to one of the edges of drawer 5. Motor 11 which activates opening and closing of the drawer 5 is advantageously designed to minimize the risk of pinched fingers, for example, by using a small connection such as in a CD drive.

In the manually activated version, this drawer comprises a gripping handle 14 on the front surface.

In a preferred version, drawer 5 moves to an extreme position that is stopped by a block comprising a sensor to ensure that drawer 5 is completely closed.

Drawer 5 is formed of a support frame 15 holding a tilting receiving platform 16. This receiving platform 16, shown in FIGS. 9-11, has a groove 17 in which a filter holder 18 engages, that is, a plate comprising two receptor cavities 19 each serving as a housing for a perforated cupel 20.

These cavities 19 that form housings each have an evacuation channel on the upper surface. Each of the evacuation channels communicates through a passageway extending into an evacuation conduit 21 by a flow device 22 serving as a dispenser for the cup 23 or mug.

Each cavity 19 forms a base for a perforated cupel 20 usually referred to as a strainer. A pod 24 containing the serving of coffee to be extracted is placed in either or both cavities for each usage.

Each strainer 20 is attached in a filter-holding cavity 18 with one or more pins. In a variation of the embodiment, it is also possible to construct filter-holding plate 18 with receptor cavities from the same piece as strainers 20.

Receiving platform 16 tilts on a front transverse axle and is blocked in the rear during the entire coffee preparation process by a locking mechanism, for example, two locking catches such as catches 25. Receiving platform 16 tilts partly due to gravity at the end of the preparation phase between a horizontal operating position and an inclined ejection position toward the base of the pod or pods 24, which in the ejection position it reaches after being freed from locking catches 25. It can also be pushed as far as the beginning of the opening by springs for detecting pods 24, with the initial force being adjusted by modifying the point of opening.

The frame 15 forming the mechanical support for drawer 5 comprises stops at the level of the axle on which receiving platform 16 tilts, such as, for example, two buffer stops made of flexible material producing a shock at the same time that platform 16 tilts downward that is sufficient to quickly and systematically eject pods 24 from their receptacle with making any unpleasant metallic sounds.

A hopper 26 guides empty pods 24 as they fall into a used pod receptacle located at the bottom of machine 3 or beneath it (not shown).

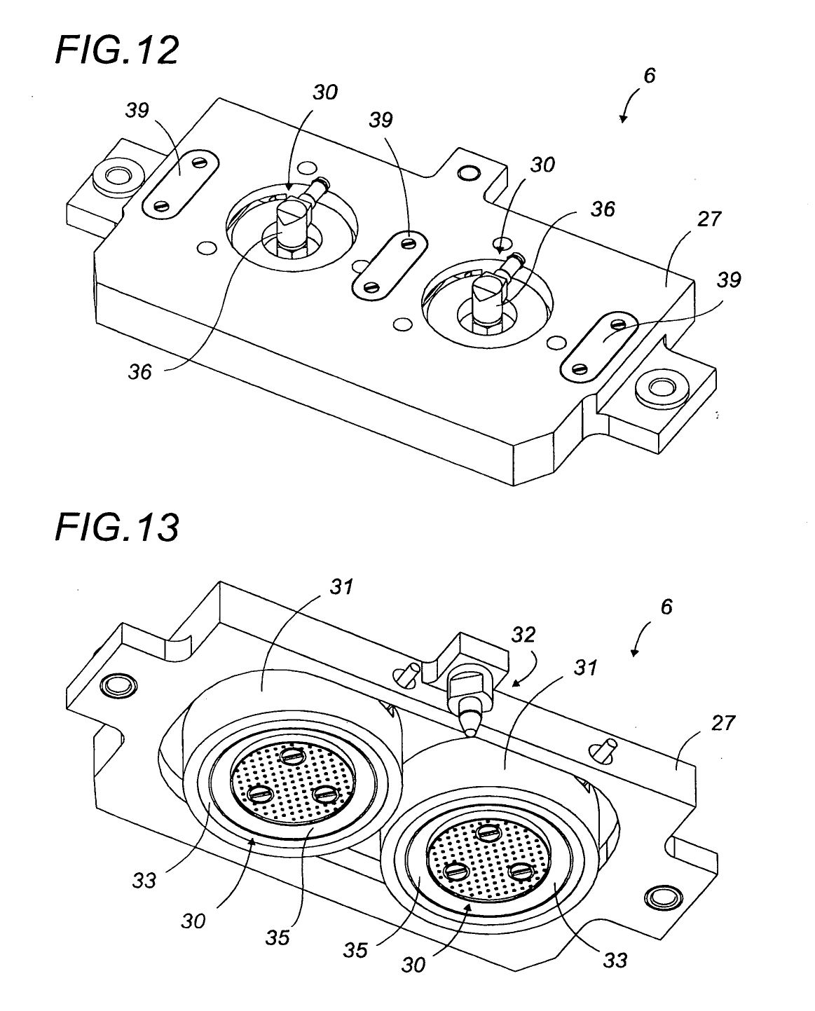

The unit is enclosed at the top by injection block 6 shown in its entirety in FIGS. 12-14. It is formed of a movable metal support plate 27 which can be elastically recalled to the top by means of symmetrical elastic forces, for example, two springs such as springs 28 provided in the lateral walls of metal support 4 of preparation unit 1 of the invention. Injection block 6 is activated to descend by contact with the projections on several cams, for example, three cams 29 held by or formed on cam shaft 7 driven in rotation by single central drive motor 8 through a pinion type reduction transmission 9.

Movable metal plate 27 on injection block 6 holds two spray heads such as spray heads 30, each attached to move like a piston in a corresponding protective cylinder 31 or protective sleeve, projecting from the lower surface.

In a preferred embodiment, injection block 6 is attached to the mechanical support of the unit using connecting elements 32 with a cone shaped attachment. This allows it to be correctly positioned above tilting receiving platform 16 during its descent.

Injection block 6 actually descends in such a way that the lower rim of the protective sleeve 31 of each spray head 30 comes into close contact with the upper rim of filter-holder plate 18 in drawer 5, forming a sealed extraction chamber essentially shaped like pod 24.

In order to form this seal, the lower portion of protective sleeves 31 on injection block 6 comprise a sealing element, for example, a toric gasket 33 housed in a circular groove 34.

In order to conform perfectly to the shape of pod 24, the lower edge of protective sleeve 31 on each spray head 30 has a concave beveled portion 35 with a rounded profile whose curve generally corresponds to the curved edges of pods 24.

Each spray head 30 is hydraulically connected at its upper extremity by a connector 36, for example, a beveled connector, to a hot water inlet conduit.

Each spray head 30 takes the form of a water diffusion head with a flat perforated front surface and a rear inlet connected to the pressurized hot water intake circuit on the machine through various control and safety devices.

Each spray head 30 is associated with a device 37 for detecting the presence of a pod 24, for example, a device based on abutting contact of its front portion with the upper surface of pod 24.

Presence detector 37 may take the form of a micro-switch or contact activated to close by the internal extremity of the body of spray head 30 or to open when the front surface of spray head 30 abuts the upper surface of pod 24. Detection can occur by forming or breaking contact. This operation will be explained more fully in the portion devoted to operation.

In order to effectively coordinate the operational cycle, it is necessary to know the position of cam shaft 7 during the principal phases. To accomplish this, cam shaft 7, driven by its drive motor 8 and motion transmission 9, comprises, at one extremity, an angular position detector 38, for example, a detector of the upper and lower neutral point of the cam shaft. In a preferred embodiment, these two positions are detected with the help of a projecting local zone formed on the perimeter of the extremity of the cam shaft, which when the cam shaft is rotating enters into contact during each rotation with one of several opposing sensors on the extremity of cam shaft 7. It is the contact with these sensors that transmits information on the position of cam shaft 7. It is in the upper neutral position when the projection is in contact with the first sensor, and in the lower neutral position when the projection is in contact with the second sensor.

The pressing movement of cams 29 on plate 27 of injection block 6 takes place in the following way. The projecting portions of cams 29 come into contact with and press against injection block 27 movable along sliding contacts 39. For this reason, the projections on the cams are shaped so that all the movements by the injection block take place during a single rotation of cam shaft 7.

It should be noted that a single electric drive motor 8 is used for the entire operational cycle, always turning in the same direction. It is not necessary to associate it with any kind of wear recovery system because the contact between cam 7 and injection block 6 preferably consists of rolling movement along a non-deformable stainless steel slide. Moreover, a single motor such as motor 8 operating regularly and always turning in the same direction is less susceptible to breakdown, considerably increasing the reliability of the unit.

The system for transmitting movement 9 between the output of the single motor 8 and the elements it controls can take place in different ways. In the preferred embodiment, this transmission uses a pinion system attached to the extremity of the electric motor 8 and to the cam extremities.

The preceding description shows a reliable preparation unit 1 that is economical to manufacture. This unit 1 accommodates at least one and at the most two pods 24. It comprises an individual means for detecting the presence of each pod 24 for each pod placement location.

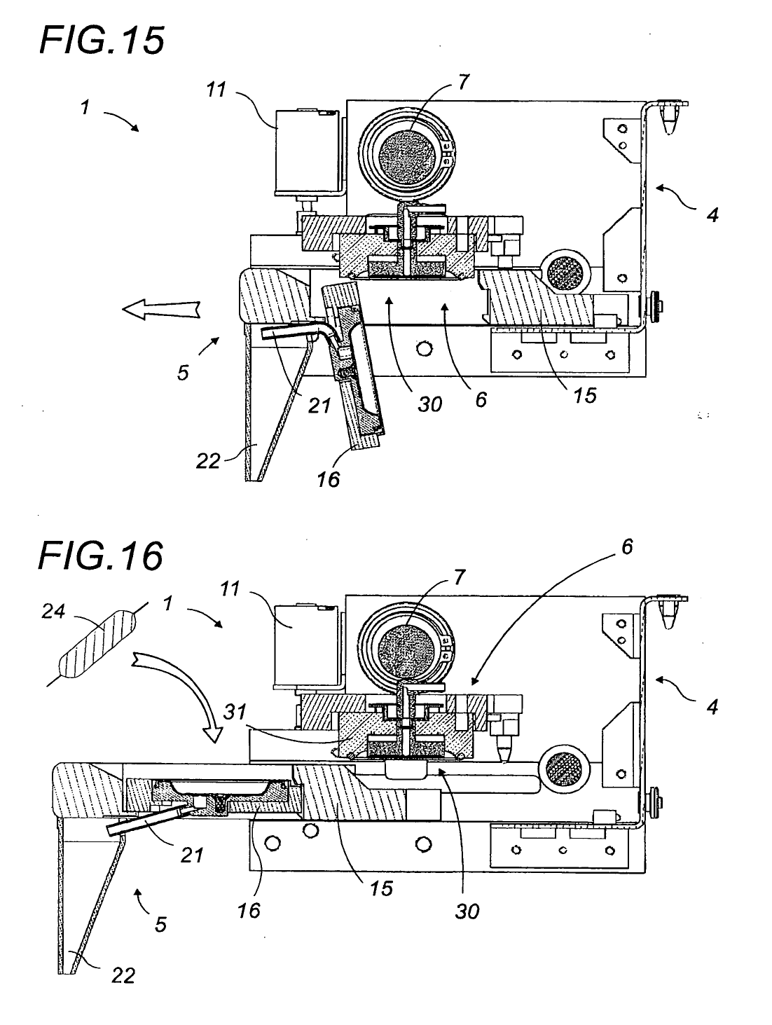

With reference to FIGS. 15-25, we will now proceed with a detailed description of the operation of a preparation unit 1 according to the invention and its mode of use by describing in detail the different stages forming one complete cycle.

In the embodiment described, the complete operating cycle takes place during a single rotation by cam shaft 7.

If several units 1 according to the invention are in use simultaneously, the mode of use is the same, as the units operate independently.

FIG. 15—Resting Position and Initial Position

Drawer 5 is in closed position and tilting receiving platform 16 is freed from locking elements 25. In the preferred embodiment the platform 16 is nearly vertical. It is empty and in the open air, ensuring that the device remains sanitary.

FIG. 16—Drawer Opening

The operator grips handle 14 and pulls drawer 5 towards himself as far as the stopping device allows. Tilting receiving platform 16 comes into contact with a pivoting roller located below its pivot axle, causing it to tilt upwards and assume a horizontal position. It is maintained in closed position by locking catches 25.

In a variation, the opening and closing of drawer 5 may be motorized by a second motor 11 associated with drawer 5, for example, with a rack system. In that case, engaging motor 11 is sufficient to place drawer 5 in position for loading.

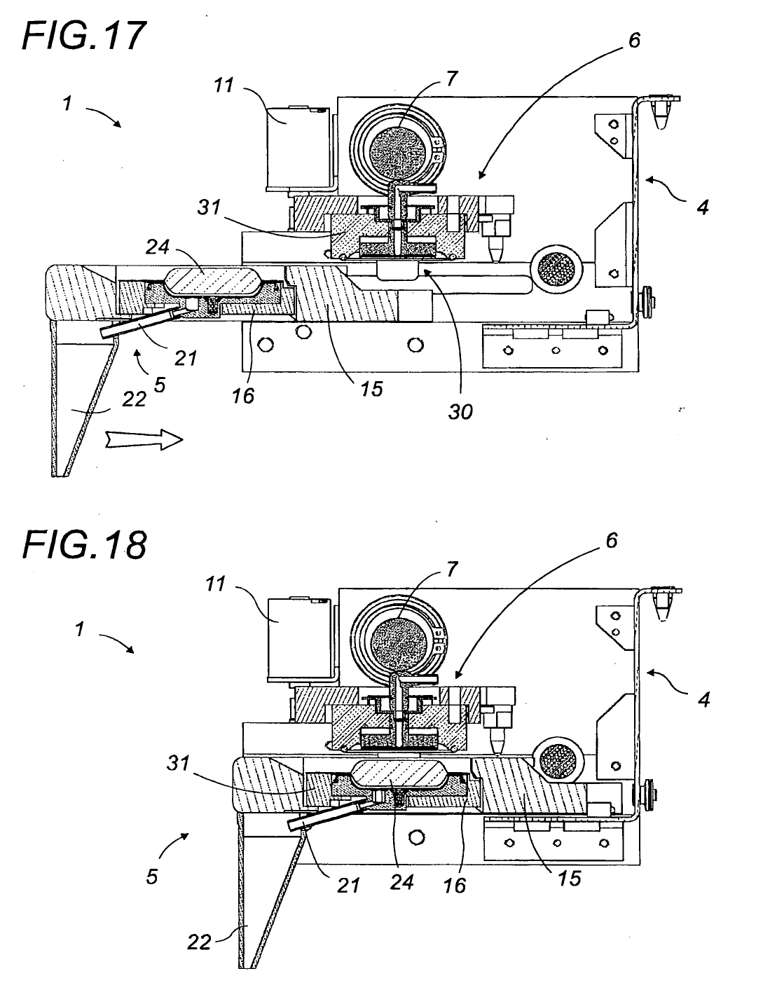

FIG. 17—Depositing Pods and Positioning Cups

The operator deposits a pod in one or both strainers 20 in the block. Since strainer 20 is shaped like a circular basin with a diameter generally equal to or slightly different from that of pods 24, positioning pod 24 in strainer 20 is simple and quick. Because there is optimal access to strainers 20, the placement of pod 24 is simple, quick, and free of danger.

Simultaneously, the operator places a coffee cup 23 beneath the spout 22 corresponding to each strainer that contains a pod 24, or one cup 23 beneath the two outlets.

FIG. 18—Drawer Closing

The operator pushes drawer 5 in mechanical support 4 as far back as the blocking device allows.

Advantageously, this blocking device may comprise a sensor to detect whether drawer 5 is tightly closed. This safety feature ensures that the drawer is properly positioned.

Not shown—Selecting the Quantity of Coffee

The operator selects the quantity of coffee desired on the machine, which is generally referred to as a large or small coffee. For this purpose the operator has a choice of different volume selections for a corresponding unit. If a small coffee is selected and there is one pod, a small coffee is obtained. If a small coffee is selected and there are two pods, two small coffees are obtained.

The operator does not need to question whether he has placed one or two pods (24) and if he has positioned only one, there is no need to question on which side.

Once the selection has been made, the single motor 8 of the unit of to the invention is engaged in operation.

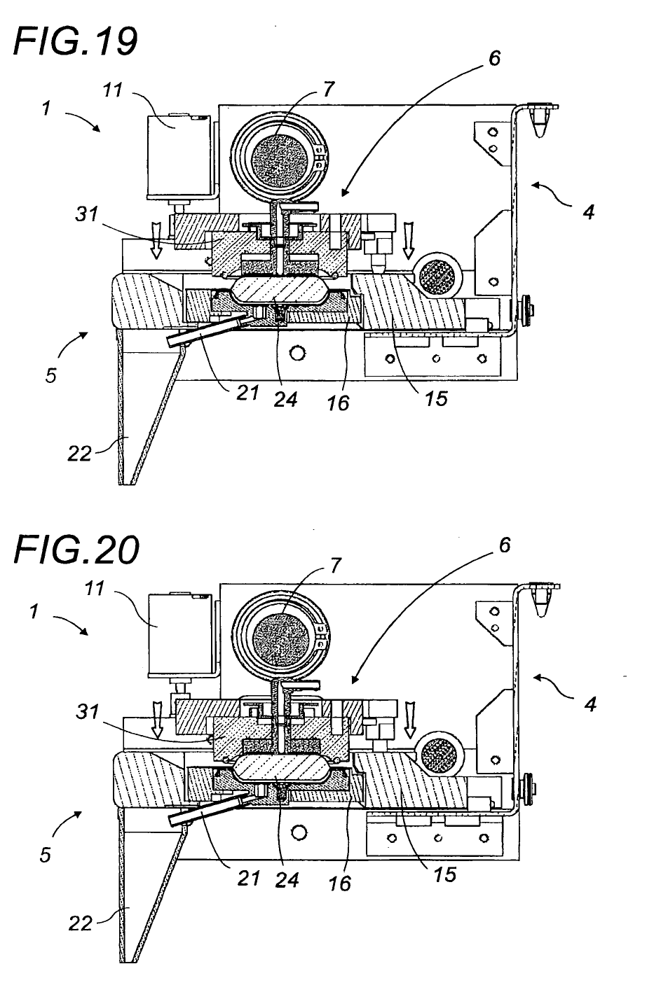

FIG. 19—Lowering Injection Block

Single motor 8 drives cam shaft 7 in rotation which causes injection block 6 to descend through contact with the projection on the cams.

FIG. 20—Detecting Presence of a Pod

During the descent of injection block 6, each spray head 30 is in the lowered position and its lower surface is essentially flush with that of protective sleeve 31.

During this descent if a pod 24 is present in strainer 20, the upper surface of the strainer comes into contact with the lower surface of spray head 30. While injection block 6 continues to descend in order to contact filter-holding plate 18 in drawer 5, spray head 30 remains immovable relative to mechanical support 4, causing it to move up into its protective sleeve 31 to the level corresponding to the portion of pod 24 projecting beyond strainer 20.

Once it has reached the upper position in its protective sleeve 31, the upper portion of the body of spray head 30 activates the pod presence detector 37.

During this descent, if a strainer 20 does not contain a pod 24, the corresponding spray head 30 does not move up inside its protective sleeve 31 and the pod presence detector 37 is not activated.

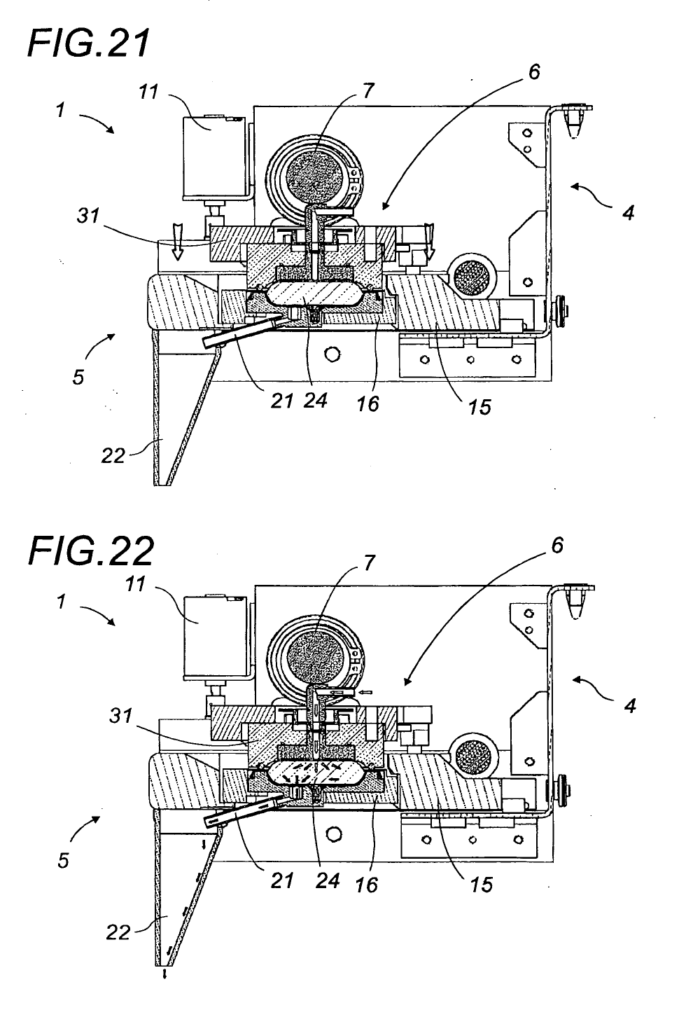

FIG. 21—Sealing Extraction Chamber

Injection block 6 continues to descend until the lower edge of the protective sleeve 31 of each spray head 30 tightly contacts the upper edge of filter-holding plate 18 in drawer 5 to form a sealed extraction chamber.

This stage takes place simultaneously with the preceding stage.

Not shown—Detecting Neutral Low Point of Cam Shaft

When the extraction chamber is closed, that is, when injection block 6 is in the lowered position, angular position detector 38 detects the neutral low point of cam shaft 7.

As indicated in the preferred embodiment, this position is detected through the use of a projection formed on the perimeter of the extremity of cam shaft 7 which comes into contact with the neutral low position sensor.

FIG. 22—Preparation of Coffee

The low neutral position sensor activates the hydraulic system that sends the quantity of water selected during the coffee quantity selection stage through each of spray heads 30 for which the presence of a pod 24 has been detected during the stage of pod 24 detection.

The water, represented by white arrows, passes through the selected spray head 30, then through pod 24, strainer 20, evacuation conduit 21, and pour spout 22 associated with it, finally flowing into the coffee cup placed beneath the spout.

The coffee extracted after the water has passed through pod 24 is shown by black arrows.

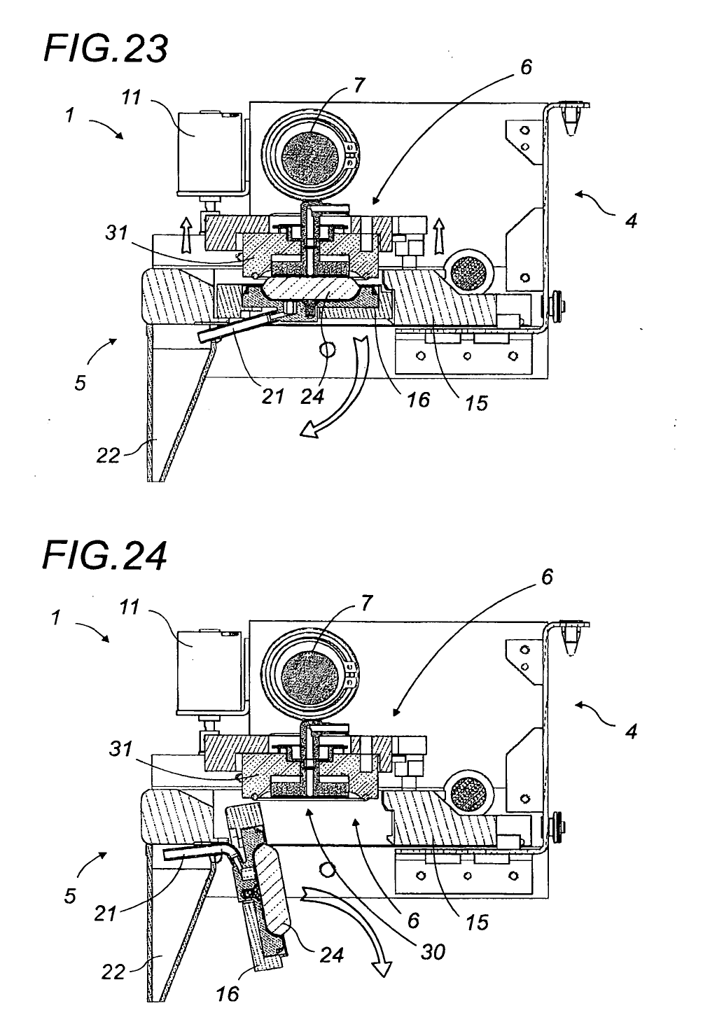

FIG. 23—Decompression of Extraction Chambers

Several instants after extraction is complete, cam shaft 7 begins to turn again, gradually eliminating the contact by the projections on cams 29. Symmetrical elastic forces in the form of two springs 28 recall injection block 6 upward.

The pieces forming the extraction chambers disassociate, causing decompression to occur.

This decompression may cause a certain amount of water and coffee to travel up through the hydraulic system of machine 3, which dirties it over the course of time.

The use of a triple track valve prevents the pod from being filled with water when it is ejected, thereby eliminating spattering and keeping the device clean. Such a device using a triple track valve is known in the art and will not be described in detail.

After the extraction chamber is decompressed, any used pods 24 remain in strainers 20.

FIG. 24—Tilting of Receiving Platform

Cam shaft 7 continues to turn and the cam transmission system controls opening of catches 25 on the mechanism for locking tilting receiving platform 16. The platform tilts partially by gravity on its pivot axle until it is nearly in the vertical position, striking the buffer stop blocks made of flexible material.

The shock this causes produces a muffled sound. Its purpose is to eject used pods 24 from their receptacle 20. Pods 24 then fall by gravity and are guided in their fall by hopper 26 to a used pod receptacle.

During this stage, spray heads 30 are in free contact with pods 24, and the force they exert on the pods helps pods 24 to dislodge from receptacle 20 by increasing the opening speed and thereby the impact at the end of the course.

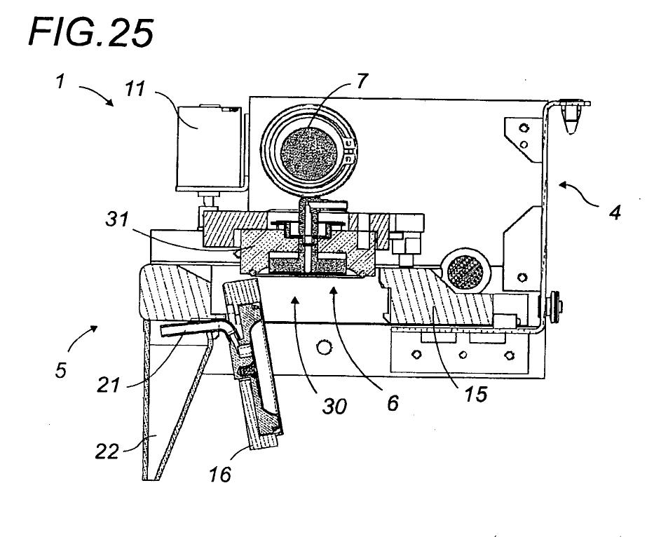

FIG. 25—Assumption of Resting Position

Cam shaft 7 continues to turn as the injection block 6 reaches the upper position. Angular position detector 38 then detects the upper neutral position of cam shaft 7 and cuts motor 8.

Drawer 5 remains in closed position and tilting receiving platform 16 is freed from locking elements 25. It is empty and in the open air, which considerably reduces any sanitation risk for the device. Unit 1 is in the final position, which is also the initial position in FIG. 15. It is ready to recommence another cycle.

A reading of the preceding description of a cycle makes it apparent that preparation unit 1 of the invention is simple to use, free of danger for the operator, and fully responsive to sanitation requirements.

This automatic cycle requires electronic automation circuits that have not been described. Actually, the design for electronic circuits adapted to the specifics of the preparation unit is based upon simple studies of automation.

In the preferred embodiment previously described, drawer 5 is manually activated. As indicated, however, it may be motorized using an auxiliary motor device, said motor 11 possibly being activated to close the drawer when the operator selects the quantity of coffee or through the use of a dedicated button, and to open it during the step of positioning pods 24 in which drawer 5 will be opened from the resting position in which it is closed.

It is also possible to conceive of numerous variations of the preceding design and operating embodiments without departing from the scope of the invention.

For example, the operating stages may be modified to adapt to the user's requirements, for example, by providing a resting position in which drawer 5 is open instead of closed.

It is also possible to adapt unit 1 of the invention to other shapes of pods 24. To do this, it is only necessary to adapt the shape of strainers 20 and pods 24, without any need to modify the remainder of machine 3.

It is also possible to adapt unit 1 of the invention to machines 3 for household use rather than commercial use.

Additionally, it is possible to adapt the automation system to make it possible to simultaneously prepare a small coffee from one pod and a large coffee from the other.

A very interesting improvement also consists of providing an identification code on pods 24 that can be read by a device adapted to unit 1 of machine 3 for recognizing the type of pod 24 being used. This identification code might consist, for example, of a bar code, an electronic chip, a magnetic imprint, or a raised and/or recessed impression or other means, that is respectively read by an optical, magnetic, electronic, mechanical, or other reading device.

It is also possible to differentiate the pods according to the type of coffee they contain so the machine can consequently adapt the amount of water, its temperature, pressure, and more generally, all the parameters of the machine according to these characteristics, with this process taking place individually for each pod and the unit of the invention incorporating an extraction chamber and an individual presence detector for each pod, as well as a specific hydraulic system for each strainer and thus for each pod.

The device for reading pod identification codes to be provided on each strainer requires no description because it already exists in theory.

In this embodiment, it would also be possible to replace the individual mechanical presence detectors for each pod by the identification code reader, adapting it for this purpose.

1-26. (canceled)

27. A unit (1) for automatic preparation of one serving of a hot beverage from a quantity of dry product previously measured and contained in a package called a pod (24), the unit being mounted in a hot beverage preparation machine (3) using a drawer (5) and a receiving platform (16) for accommodating at least one of the pods (24), the unit (1) comprising:
a drawer (5) movable between an extraction position for extracting the at least one pod (24), a position for loading the at least one pod (24), and a position for discharging the at least one pod (24);
an injection block (6) closing a front portion of a support (4) above the drawer (5) when in the extraction position, the injection block (6) being movable toward and away from the drawer (5);
a cam shaft (7) biasing the injection block (6) to move towards the drawer (5), and a return movement, away from the drawer (5), being accomplished automatically using a recall force (28);
a single drive motor (8) for driving the cam shaft (7), and the cam shaft (7) having at least one cam (29); and
a motion transmission means (9) located between an output of the drive motor (8) and elements the drive motor (8) controls.

28. The preparation unit (1) according to claim 27, wherein the at least one cam (29) enables all movement of the injection block (6) with a single rotation of the cam shaft (7) which is driven to rotate in a same direction by the single drive motor (8) by way of a pinion reduction transmission (9).

29. The preparation unit (1) according to claim 28, wherein the at least one cam (29) has projections that press against the injection block (6) near sliding contacts (39) which are used during a descent of the injection block (6).

30. The preparation unit (1) according to claim 27, wherein the cam shaft (7) comprises, at one extremity, an angular position detector (38).

31. The preparation unit (1) according to claim 30, wherein the angular position detector (38) detects an upper position of the cam shaft (7) and a lower neutral position of the cam shaft (7).

32. The preparation unit (1) according to claim 27, wherein the injection block (6) is formed of a movable metal support plate (27) which is attached to be elastically recalled toward a top by elastic forces (28).

33. The preparation unit (1) according to claim 32, wherein the movable metal plate (27) on the injection block (6) comprises two spray heads (30) connected to a hydraulic circuit which is integrated within a remainder of the hot beverage preparation machine (3).

34. The preparation unit (1) according to claim 33, wherein each of the two spray heads (30) is a water diffusion head having a flat perforated front surface and a rear inlet connected to a pressurized hot water supply circuit of the hot beverage preparation machine (3) through at least one control and safety device.

35. The preparation unit (1) according to claim 33, wherein each of the two spray heads (30) are attached to move like a piston within a protective sleeve (31) projecting from a lower surface of the movable metal support plate (27).

36. The preparation unit (1) according to claim 35, wherein a lower portion of the protective sleeves (31) on the injection block (6) comprises a sealing element (33).

37. The preparation unit (1) according to claim 35, wherein a lower edge of the protective sleeve (31) of each spray head (30) has a concave beveled portion (35) rounded in shape with a curve essentially corresponding to a rounded edge of the at least one pod (24).

38. The preparation unit (1) according to claim 33, wherein each spray head (30) communicates with a detector (37) for detecting the presence of the at least one pod (24), and the detector (37) is based on a front portion of the spray head (30) being blocked by contact with an upper surface of the at least one pod (24).

39. The preparation unit (1) according to claim 38, wherein the pod presence detector (37) comprises one of a micro-switch and a contact having contacts that are actuated to one of open and close, by blocking, an internal extremity of a body of the spray head (30) when the front portion of the spray head (30) contacts the upper surface of the at least one pod (24).

40. The preparation unit (1) according to claim 27, wherein the drawer (5) is a unit that moves on rollers (10) in a horizontal translation between an extended position and a retracted position.

41. The preparation unit (1) according to claim 40, wherein the drawer (5) is biased by an auxiliary motor (11) and a pinion drive (12) which engages a rack (13) affixed to a support on the drawer (5).

42. The preparation unit (1) according to claim 27, wherein the drawer (5) comprises a support frame (15) supporting a tilting receiving platform (16).

43. The preparation unit (1) according to claim 42, wherein the tilting receiving platform (16) communicates with the support frame (15) such that the platform (16) pivots on a front transverse axle and is maintained in a working position by a locking mechanism at a rear end of the platform (16).

44. The preparation unit (1) according to claim 43, wherein the locking mechanism comprises two locking catches (25).

45. The preparation unit (1) according to claim 43, wherein the receiving platform (16) is maintained in the working position during an entire hot beverage preparation operation by the locking mechanism, after being freed from the locking mechanism, the receiving platform (16) tilts from a horizontal operating position, at an end of the hot beverage preparation operation, to a downwardly angled ejection position, which the receiving platform (16) assumes through gravity.

46. The preparation unit (1) according to claim 42, wherein the receiving platform (16) has a groove which engages a filter-holder (18) comprising two receptor cavities (19), each housing one of a perforated cupel and a strainer (20) and each of the two receptor cavities (19) having an evacuation channel (21) in an upper surface, and at least one pod (24), containing coffee to be extracted, is placed in one of the perforated cupel and the strainer (20).

47. The preparation unit (1) according to claim 46, wherein each of the evacuation channels communicates through a passageway extending through a flexible evacuation, conduit (21) with a flow piece (22), and the flow piece (22) being a dispensing spout.

48. The preparation unit (1) according to claim 42, wherein the frame (15) providing mechanical support for the drawer (5) comprises at least one stop.

49. The preparation unit (1) according to claim 48, wherein the at least one stop is a buffer made of a flexible material.

50. The preparation unit (1) according to claim 27, wherein downward movement of the injection block (6) into the extraction position causes a lower edge of a protective sleeve (31) of each spray head (30) to communicate with an upper edge of a filter-holder plate (18) on the drawer (5) forming a sealed extraction chamber shaped essentially like the pod (24).

51. The preparation unit (1) according to claim 27, wherein a hopper (26) guides a used pod (24) as the used pod (24) falls into a waste receptacle located at one of a bottom of the preparation machine and beneath the preparation machine (3).

52. The preparation unit (1) according to claim 27, wherein the preparation unit (1) further comprises at least one ofan optical, a magnetic, an electronic, a mechanical and another type device for reading identification codes supplied on the pods (24).
